(19) United States
(12) Patent Application Publication
(10) Pub. No.: US 2004/0246214 A1
(43) Pub. Date: Dec. 9, 2004

(54) Liquid crystal display and sampling circuit therefor

(75) Inventors: Jian-Shen Yu, Hsinchu (TW); Wei-Jen Lo, Pingtung (TW); Chang-Yu Chen, Kaohsiung (TW)

Correspondence Address: LADAS & PARRY, 5670 WILSHIRE BOULEVARD, SUITE 2100, LOS ANGELES, CA, 90036-5679, US

(73) Assignee: AU Optronics CORP.

(21) Appl. No.: 10/783,474

(22) Filed: Feb. 20, 2004

(30) Foreign Application Priority Data
May 19, 2003 (TW) 92113436

(51) Int. Cl. G09G 3/36

(52) U.S. Cl. 345/87

(57) ABSTRACT

A video sampling circuit of a liquid crystal display with a merit of feed-through voltage reduction was disclosed. The sampling circuit comprises a first thin film transistor (TFT) and a counteracting device. The first TFT has a first electrode to receive the analog signal, a control electrode to receive the clock signal, and a second electrode, and samples the analog signal when the clock signal is at a first logic level. The counteracting device is coupled to the second electrode. When the clock signal is changed from the first logic level to a second logic level, a feed-through voltage drop caused by a parasitic capacitor between the second electrode and the control electrode of the first TFT is reduced.

### BACKGROUND OF THE INVENTION

1. Field of the Invention

The present invention relates to a sampling circuit, and particular to a sampling circuit for a liquid crystal display to reduce feed-through voltage drop caused by a parasitic capacitor.

2. Description of the Related Art

FIG. 1 shows a schematic diagram of a conventional liquid crystal display panel (hereinafter, referred to as a “LCD panel”) and the peripheral driving circuit thereof. As shown in FIG. 1, an LCD panel is formed by interlacing data electrodes (represented on D1, D2, D3, . . . , Dm) and gate electrodes (represented on G1, G2, G3, . . . , Gm), each of the interlacing data electrodes and gate electrodes controls one display unit. For example, the interlacing data electrode Di and gate electrode G1 control the display unit 200.

When the gate electrode G1 carries a scan signal, transistors (Q11, . . . , Q1m) of the display units on the same row are turned on. Next, as the gate electrode G1 is selected, a sampling circuit 11 of a data driver 10 transmits a signal VS (Video signal) into the corresponding display unit through the data electrodes (D1, D2, D3, . . . , Dm) .

According to the switch status of the transistor (Q_{ASW1}˜Q_{ASWm}), the sampling circuit 11 samples the required video data and transmits the signal VS. Furthermore, the switch status of the transistors (Q_{ASW1}˜Q_{ASWm}) are determined by levels of clock signals (CLK1˜CLKm). For example, when the level of the clock signal CLK1 is high, the transistor Q_{ASW1} is turned on and transmits the corresponding signal VS (grayscale value). Then, when the level of the clock signal CLK1 is changed from high to low, a grayscale value transmitted through data electrode D1 is changed because of a feed-through voltage drop caused by a parasitical capacitance Cgd₁ of the transistor Q_{ASW1}. When a level of one terminal of the parasitic capacitor Cgd₁ is changed, another terminal is also. As a result, when the level of the clock signal CLK1 is changed from high to low, the grayscale value transmitted through data electrode D1 becomes lower, and a grayscale value stored in storage capacitor (C11˜Cn1) is also changed.

FIG. 2 shows a simulated voltage diagram of a conventional sampling circuit, in which the parasitical capacitance Cgd₁ is shown as a dashed line (as shown in FIG. 1). The grayscale value at point A in FIG. 1 is 5V when the level of the clock signal CLK is high, and drops to 4.8V when the level of the clock signal CLK is changed form high to low, and thus the variation of the grayscale value at point A is 0.2V. However, in display units, 5.0 mV represents one grayscale value, so feed-through voltage drop caused by parasitic capacitor makes display units store a wrong grayscale value. Thus, there is a need for a sampling circuit that reduces feed-through voltage drop caused by a parasitic capacitor.

### SUMMARY OF THE INVENTION

Accordingly, an object of the present invention is to provide a sampling circuit for reducing feed-through voltage drop caused by parasitic capacitor.

Another object of the invention is to provide a liquid crystal display for counteracting feed-through voltage drop caused by parasitic capacitor to accurately display the video data.

To achieve the FIRST object, the present invention provides a sampling circuit for an analog signal according to a clock signal. The sampling circuit comprises a first thin film transistor (TFT) and a counteracting device. The first TFT has a first electrode to receive the analog signal, a control electrode to receive the clock signal and a second electrode, and samples the analog signal when the clock signal is at a first logic level. The counteracting device coupled to the second electrode. When the clock signal is changed from the first logic level to a second logic level, a feed-through voltage drop caused by a parasitic capacitor between the second electrode and the control electrode of the first TFT is reduced. Moreover, the counteracting device is a capacitor between the second electrode and a reference potential node.

In addition, the counteracting device can comprise an inversion device, having an input terminal coupled to the control electrode, and a capacitor between the second electrode and an output terminal of the inversion device. Here, the capacitor comprises a second TFT, having a gate terminal coupled to the output terminal of the inversion device and a source and drain terminal both coupled to the second electrode.

To achieve the second object, the present invention provides a liquid crystal display. The liquid crystal display comprises a plurality of display units, a plurality of data lines and a data driving circuit. The display units are arranged in array. The data lines are disposed corresponding to each line of the display units, wherein each data line provides a video signal to a corresponding display unit. The data driving circuit comprises at least one sampling circuit and samples an image signal to be a video signal according to a clock signal. Here, the sampling circuit comprises a first thin film transistor (TFT) and a counteracting device. The first TFT has a first electrode receiving the analog signal, a control electrode receiving the clock signal and a second electrode, and samples the analog signal when the clock signal is at a first logic level. The counteracting device is coupled to the second electrode. When the clock signal is changed from the first logic level to a second logic level, a feed-through voltage drop coursed by a parasitic capacitor between the second electrode and the control electrode of the first TFT is reduced.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a conventional liquid crystal display panel and the peripheral driving circuit thereof.

FIG. 2 shows a simulated voltage diagram of a conventional sampling circuit.

FIG. 3 shows a schematic diagram of a liquid crystal display panel and the peripheral driving circuit thereof of the present invention.

FIG. 4a shows a first embodiment of the single sampling unit of the present invention.

FIG. 4b shows the single sampling unit of the first embodiment of the present invention.

FIG. 4c shows a simulated voltage diagram of the first embodiment of the present invention,

FIG. 5a shows a second embodiment of the single sampling unit of the present invention.

FIG. 5b shows the single sampling circuit of the second embodiment of the present invention.

FIG. 5c shows another single sampling circuit of the second embodiment of the present invention.

FIG. 6 shows the simulated voltage diagram of the second embodiment of the present invention.

FIG. 7 shows a schematic diagram of the inversion device 41.

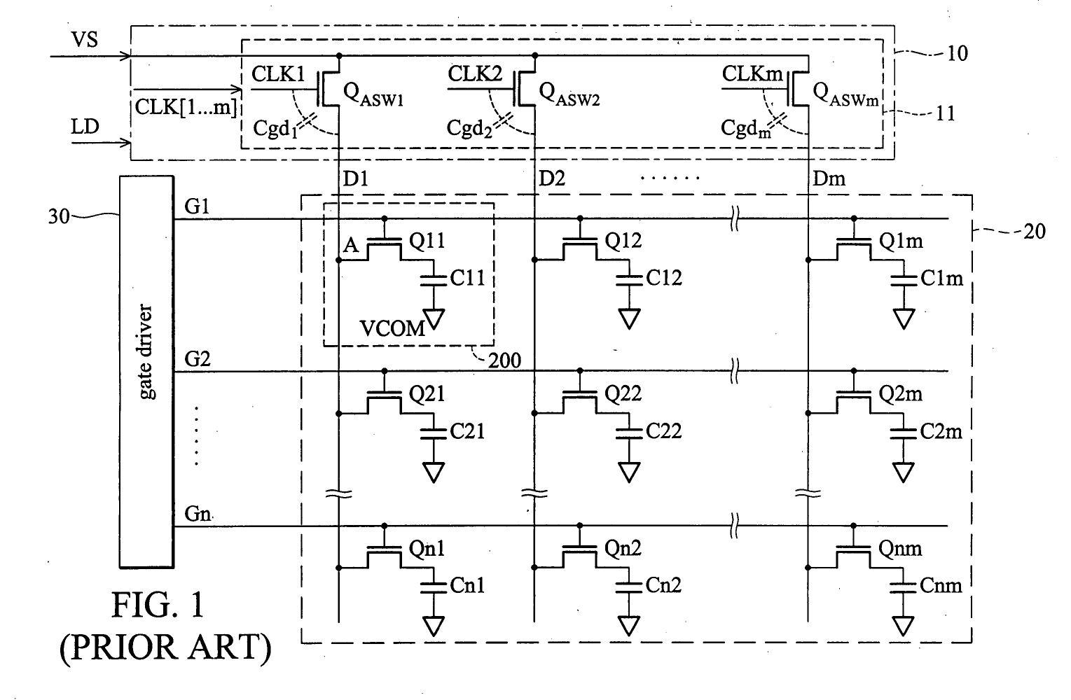

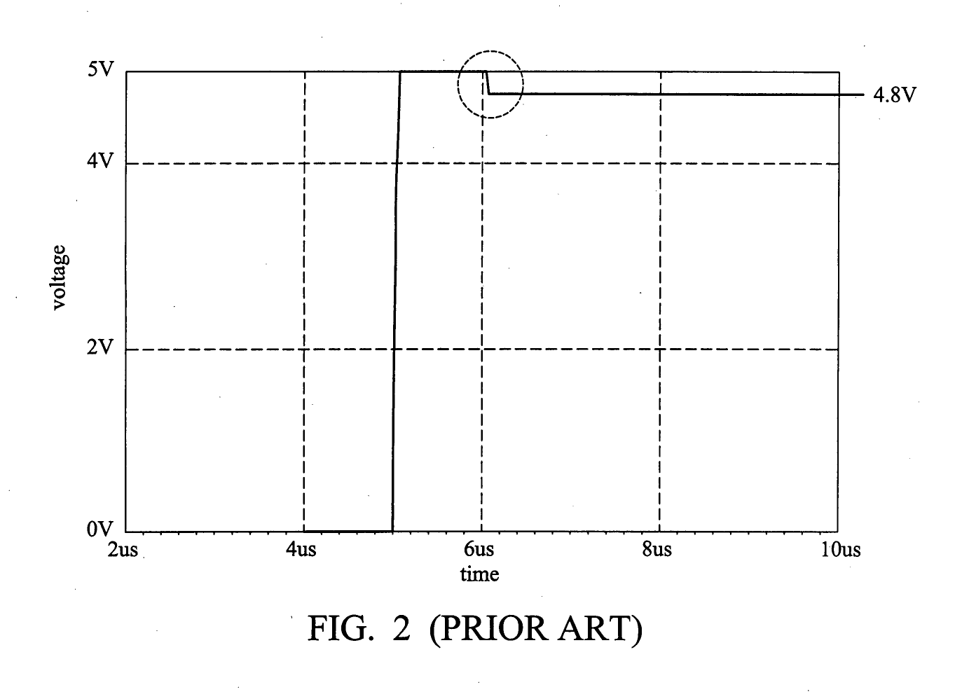

### DETAILED DESCRIPTION OF THE INVENTION

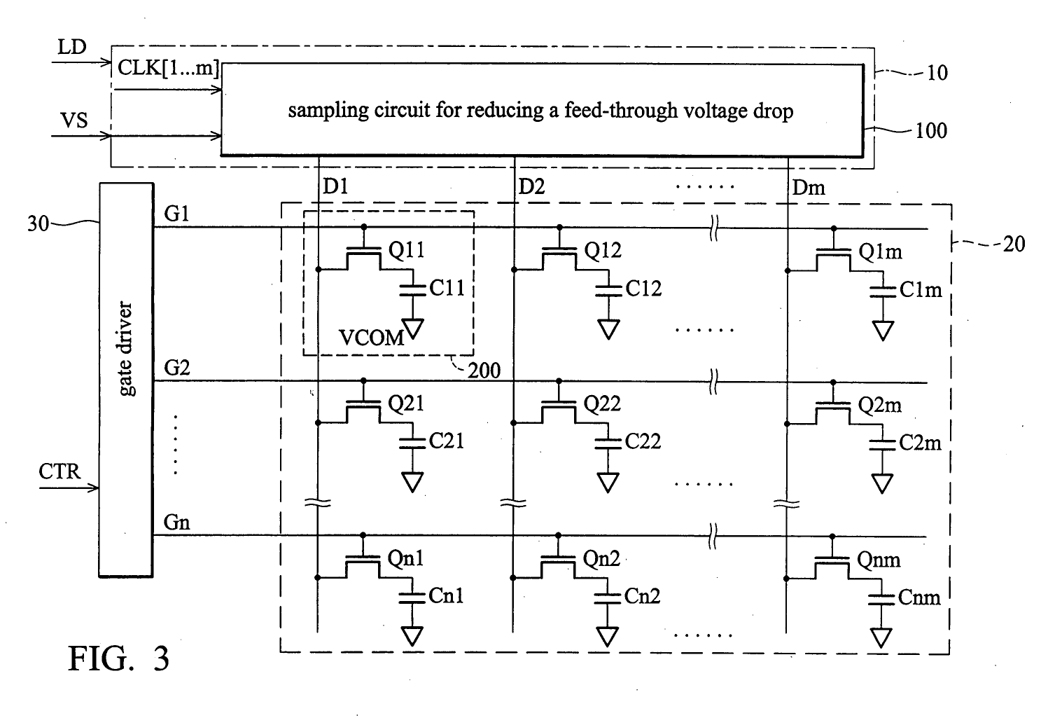

FIG. 3 shows a schematic diagram of liquid crystal display panel (hereinafter, referred to as a “LCD panel”) and the peripheral driving circuit thereof. The same reference numbers are assigned to the components having the same function as components in the prior art. As shown in FIG. 3, an LCD panel is formed by interlacing data electrodes (D1, D2, D3, . . . , Dm) and gate electrodes (G1, G2, G3, . . . , Gm), each of the the interlacing data electrodes and gate electrodes controls one display unit. For example, the interlacing data electrode D1 and gate electrode G1 can control the display unit 200.

As shown in FIG. 3, each of the equivalent circuits of the display units includes a transistor, controlling data entrance, and a storage capacitor. Drain terminals and gate terminals of the transistors are coupled to gate electrodes (G1˜Gn) and data electrodes (D1˜Dm), respectively. All the transistors on the same row are turned on/off using the scan signals on the gate electrodes (G1˜Gn), thereby controlling the video signal of data electrodes (D1˜Dm) to be written into the corresponding display units.

It is noted that each display unit controls a signal point. That is, for monochrome, each display unit corresponds to a single pixel. Moreover, for monochrome, each display unit corresponds to a signal subpixel, wherein the subpixel can be red (R), blue (B) or green (G). In other words, the subpixel composed of RGB makes up the signal pixel.

FIG. 3 also shows the driving circuit of the LCD panel. A gate driver 30 transmits the scan signals on the gate electrodes (G1˜Gn) according to a predetermined scan order. When any of the gate electrodes (G1˜Gn) carries a scan signal, the transistors on a corresponding row are turned on, and the transistors on the other row are turned off.

When any of the gate electrodes is selected, according to video data, a data driver 10 transmits the corresponding grayscale value to the m display units on the corresponding row through the gate electrodes (G1˜Gn). As soon as the gate driver 31 has finished scanning n gate electrodes, the showing of a signal frame is also done. Therefore, the object of continuously displaying images is achieved by repeatedly scanning each gate electrode and outputting the video signal. Here, a signal CTR represents a control scan signal received by gate driver 30, a signal LD represents a latch signal of the data driver 10 and a signal VS represents a video signal input.

The data driver 10, comprising a sampling circuit 100 eliminating a feed-through voltage drop, samples the signal VS according to clock signal CLK[1 . . . m] and transmits a corresponding grayscale value through data electrodes (D1˜Dm). The sampling circuit 100 comprises m sampling units, each sampling unit controlling the corresponding data electrode. The single sampling unit is described herein.

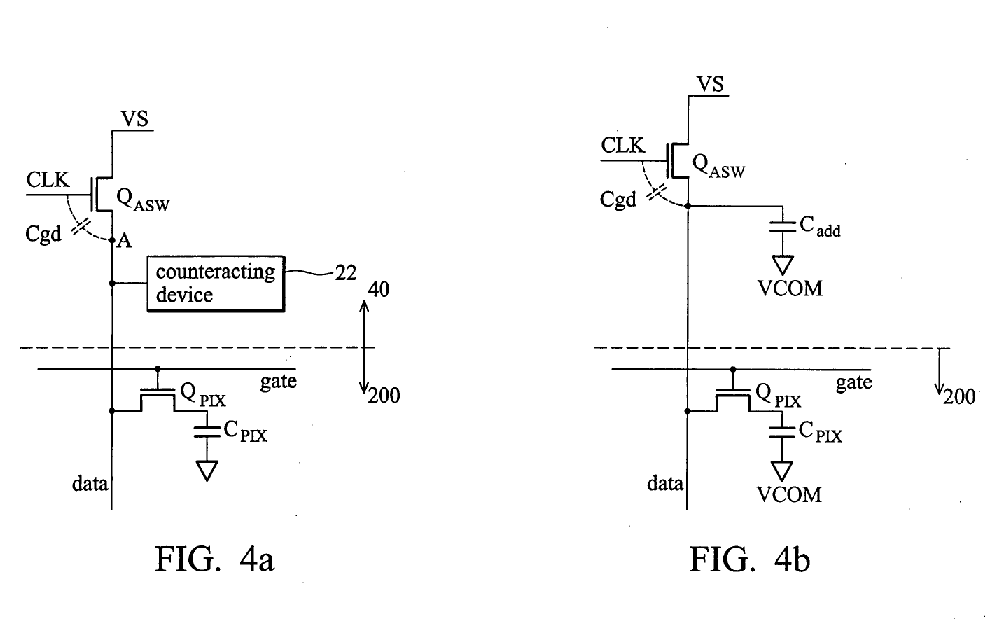

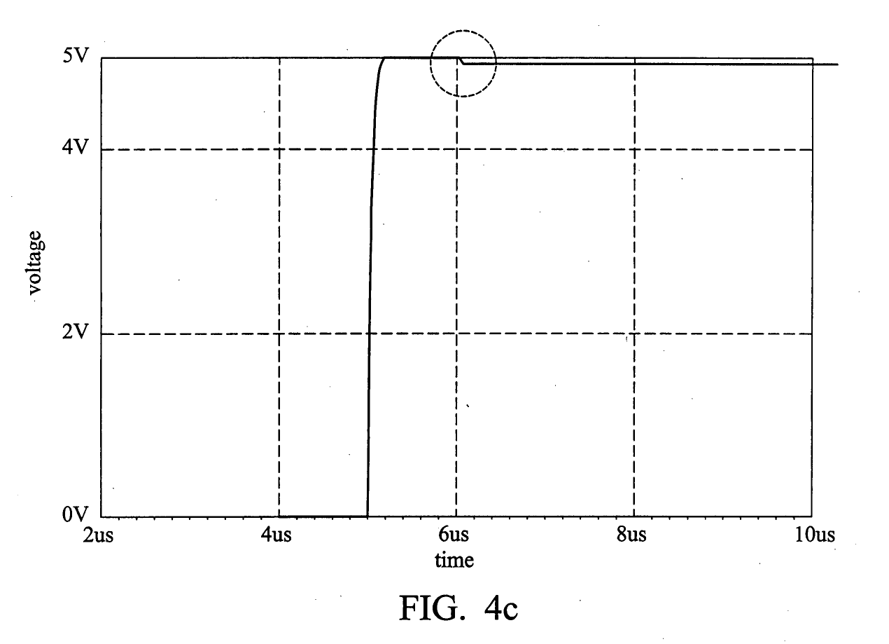

FIG. 4a shows a first embodiment of the single sampling unit of the present invention. As shown in FIG. 4a, the sampling unit 40 comprises a thin film transistor (TFT) Q_{ASW} and a counteracting device 22, coupled to a second electrode of TFT Q_{ASW}. A first electrode of TFT Q_{ASW} receives an analog signal (signal VS) and a control electrode of TFT Q_{ASW} receives the clock signal CLK. When the clock signal CLK is at a first logic level, the signal VS is sampled and output from the second electrode. When the clock signal CLK is changed from the first logic level to the second logic level, feed-through voltage drop caused by a parasitic capacitor Cgd between the second electrode and the control electrode is reduced. The labels “data” and “gate” represent the data electrode and the gate electrode.

The sampling units of the present invention in the LCD panel are made up of the same transistors. The LCD panel made up of NMOS TFTs is an example of the present invention, demonstrating operation of the sampling units.

FIG. 4b shows the single sampling unit of the first embodiment of the present invention. As shown in FIG. 4b, the counteracting device 22 is a capacitor C_{add} between the second electrode of the TFT Q_{ASW} and the reference potential node VCOM. Feed-through voltage drop ΔV is represented by the following formula:

$$Δ V = \frac{Cgd}{Ctot} Δ {V}_{DL} = \frac{Cgd}{{C}_{add} + {C}_{DL} + {C}_{PIX}} \times ( {\vert {V}_{DL} \vert}_{high} - {V}_{DL \vert low} \vert )$$

wherein Cgd represents a parasitical capacitance of the TFT Q_{ASW}; C_{add} represents a capacitance of the counteracting device 22; C_{DL} represents an equivalent capacitance of the data electrode; C_{PIX} represents a storage capacitance of the display unit 200, V_{DL|high} a voltage of the first logic level, and V_{DL|low} a voltage of the second logic level.

According to the above formula, the capacitor C_{add} can reduce feed-through voltage drop ΔV.

FIG. 4c shows a simulated voltage diagram of the first embodiment of the present invention with C_{add} of 8 pF. The grayscale value at point A is 5V when the level of the clock signal CLK is high; the grayscale value at point A is close to 5V when the level of the clock signal CLK changes from high to low. Thus, feed-through voltage drop of the first embodiment of the present invention is smaller than in the prior art.

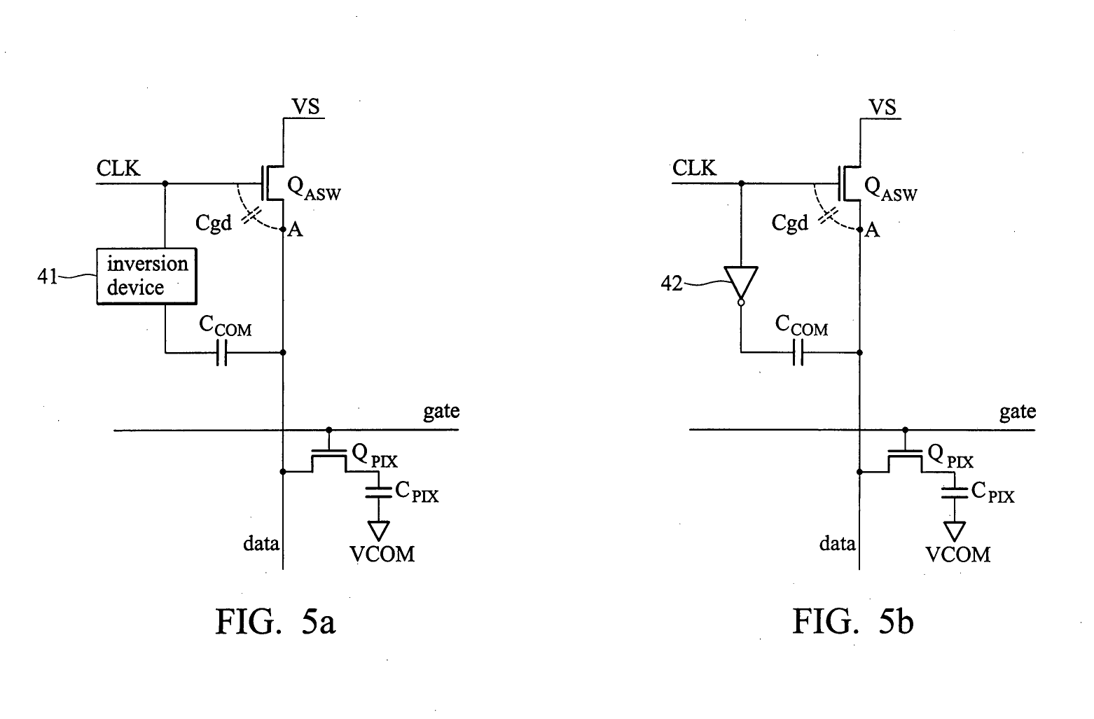

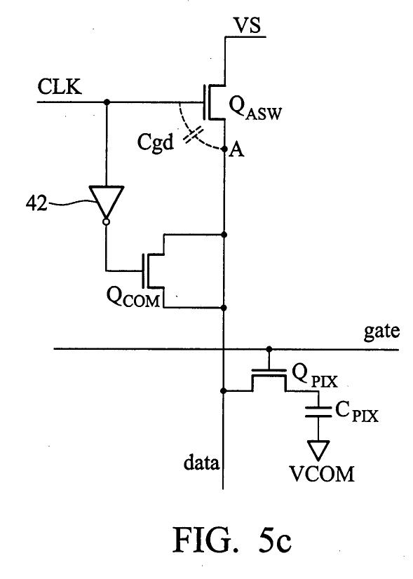

FIG. 5a shows a second embodiment of the single sampling unit of the present invention. As shown in FIG. 5a, the counteracting device 22 comprises an inversion device 41, whose input terminal is coupled to the control electrode, and a capacitor C_{com} between the second electrode and the input terminal of the inversion device 41.

FIG. 5b shows the single sampling circuit of the second embodiment of the present invention. As shown in FIG. 5b, the inversion device 41 is an inverter 42. When the level of the clock CLK is decreased low, the potential at the point A decreases correspondingly because of the parasitic capacitor. However, the inverter 42 inverts the low logic level to the high logic level, and the potential at the point A is raised through the capacitor C_{com} to reduce feed-through voltage drop caused by parasitic capacitor Cgd.

FIG. 5c shows another single sampling circuit of the second embodiment of the present invention. As shown in FIG. 5c, the TFT Q_{com} is replaced with the capacitor C_{com}. A gata terminal of the TFT Q_{com} is coupled to the output terminal of the inverter 42, and a source and a drain terminal of the TFT Q_{com} are coupled to the second electrode of the TFT Q_{ASW}.

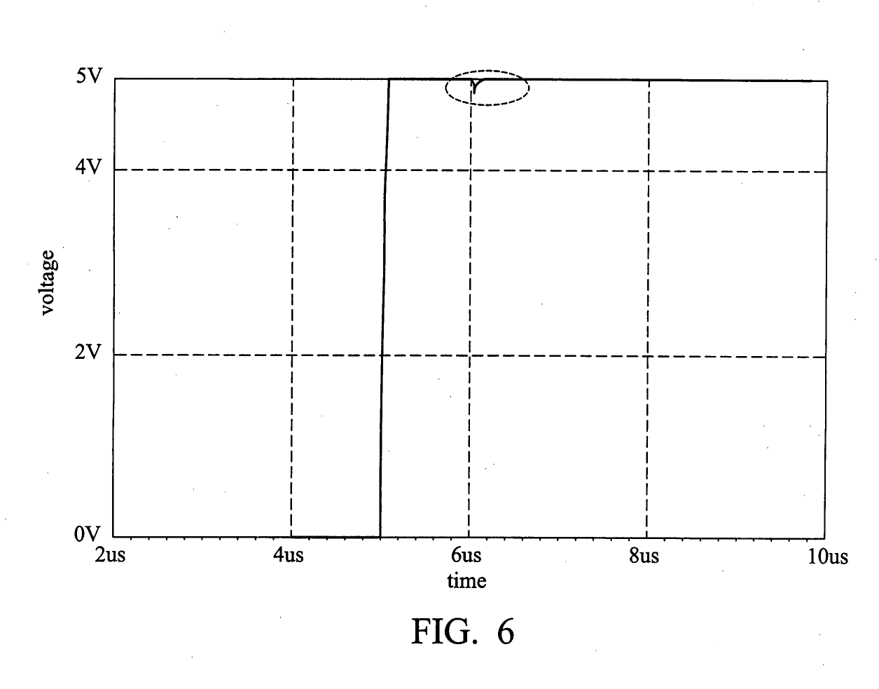

FIG. 6 shows the simulated voltage diagram of another example of the present invention. As shown by the dashed line, when the level of the clock signal CLK is changed from high to low, the potential at point A is lowered in a short period and then raised to 5V immediately. Therefore, the second example of the single sampling unit of the present invention also solves feed-through voltage drop caused by parasitic capacitor Cgd completely.

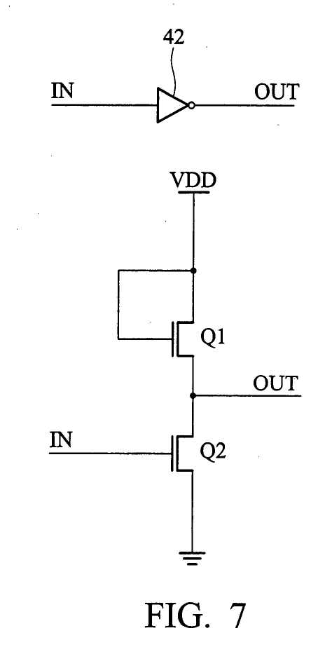

FIG. 7 shows the inversion device 41. The inversion device 41 comprises two TFTs of same conducting type, in which a gate and a drain terminal of the first TFT Q1 are coupled to a high-level voltage VDD, and the source terminal of the first TFT Q1 to the output terminal of the inversion device 41. The gate terminal of the second TFT Q2 is coupled to the input terminal of the inversion device 41, and the drain terminal of the second TFT Q2 is coupled to a low-level voltage VSS.

Thus, the present invention can effectively solve feed-through voltage drop caused by parasitic capacitor Cgd of the TFT Q_{ASW} in the single sampling unit to accurately display the video data on the LCD panel.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sampling circuit for an analog signal according to a clock signal, comprising:
a first thin film transistor (TFT), having a first electrode to receive the analog signal, a control electrode to receive the clock signal and a second electrode for sampling the analog signal when the clock signal is at a first logic level; and
a counteracting device coupled to the second electrode, wherein when the clock signal is changed from the first logic level to a second logic level, feed-through voltage drop caused by a parasitic capacitor between the second electrode and the control electrode of the first TFT is reduced.

2. The circuit as claimed in claim 1, wherein the counteracting device is a capacitor between the second electrode and a reference potential node.

3. The circuit as claimed in claim 1, wherein the counteracting device comprises an inversion device, having an input terminal coupled to the control electrode, and a capacitor between the second electrode and a output terminal of the inversion device.

4. The circuit as claimed in claim 3, wherein the capacitor comprises a second TFT having a gate terminal coupled to the output terminal of the inversion device and a source and drain terminal both coupled to the second electrode.

5. A liquid crystal display, comprising:
a plurality of display units, arranged in array;
a plurality of data lines disposed corresponding to each line of the display units, wherein each data line provides a video signal to the corresponding display unit; and
a data driving circuit, having at least one sampling circuit, sampling an image signal to be the video signal according to a clock signal, and the sampling circuit comprising:
a first thin film transistor (TFT), having a first electrode receiving an analog signal, a control electrode receiving the clock signal, and a second electrode for sampling the analog signal when the clock signal is at a first logic level; and
a counteracting device coupled to the second electrode, wherein when the clock signal is changed from the first logic level to a second logic level, a feed-through voltage drop caused by a parasitic capacitor between the second electrode and the control electrode of the first TFT is reduced.

6. The liquid crystal display as claimed in claim 5, wherein the counteracting device is a capacitor between the second electrode and a reference potential node.

7. The liquid crystal display as claimed in claim 5, wherein the counteracting device comprises an inversion device, whose input terminal is coupled to the control electrode, and a capacitor between the second electrode and an output terminal of the inversion device.

8. The liquid crystal display as claimed in claim 7, wherein the capacitor comprises a second TFT having a gate terminal coupled to the output terminal of the inversion device and a source and drain terminal, both coupled to the second electrode.
